(19) United States
(12) Patent Application Publication
(10) Pub. No.: US 2013/0073483 A1
(43) Pub. Date: Mar. 21, 2013

(54) Systems, Methods, and Apparatus for Protecting Power Transformers

(71) Applicants: John Christopher Boot, Sandy Springs, GA (US); Kenneth Caird, Smyrna, GA (US)

(72) Inventors: John Christopher Boot, Sandy Springs, GA (US); Kenneth Caird, Smyrna, GA (US)

(73) Assignee: GENERAL ELECTRIC COMPANY, Schenectady, NY (US)

(21) Appl. No.: 13/234,442

(22) Filed: Sep. 16, 2011

(51) Int. Cl. G06F 17/00; G05D 9/00

(52) U.S. Cl. 705/412; 700/292

(57) ABSTRACT

Certain embodiments of the invention may include systems, methods, and apparatus for protecting power transformers. According to an example embodiment of the invention, a method is provided for protecting a power transformer from overload. The method can include receiving transformer power rating information; receiving load information from individual meters supplied by the power transformer; summing the received load information; comparing the summed load information to the received transformer power rating information; and determining spare load capacity associated with the power transformer based at least in part on the comparison.

### FIELD OF THE INVENTION

This invention generally relates to electrical power distribution and power transformers, and in particular, to protecting power transformers from overload.

### BACKGROUND OF THE INVENTION

As plug-in electric vehicles become more prevalent, the existing electrical grid, and local transformers in particular, may not have enough capacity to handle the additional power load that might be required in certain areas with high plug-in electric car concentrations. When several vehicles in the same neighborhood recharge at the same time, or during the normal summer peak loads, transformer-overloading problems may arise. To avoid such problems, utilities often use incentive programs to urge plug-in owners to recharge their vehicles overnight when the grid load is lower. As the number of plug-in electric vehicles reaches significant levels, utilities may have to invest in improvements for local electrical grids in order to handle the additional loads related to recharging to avoid blackouts due to grid overload.

### BRIEF SUMMARY OF THE INVENTION

Some or all of the above needs may be addressed by certain embodiments of the invention. Certain embodiments of the invention may include systems, methods, and apparatus for protecting power transformers.

According to an example embodiment of the invention, a method is provided for protecting a power transformer from overload. The method can include receiving transformer power rating information; receiving load information from individual meters supplied by the power transformer; summing the received load information; comparing the summed load information to the received transformer power rating information; and determining spare load capacity associated with the power transformer based at least in part on the comparison.

According to another example embodiment, a system is provided. The system includes one or more meters; at least one power transformer operable to provide power to the one or more meters; at least one memory for storing data and computer-executable instructions; and at least one processor configured to access the at least one memory and further configured to execute the computer-executable instructions for: receiving power rating information for the at least one power transformer; receiving load information from the one or more meters supplied by the at least one power transformer; summing the received load information; comparing the summed load information to the received power rating information; and determining spare load capacity associated with the least one power transformer based at least in part on the comparison.

According to another example embodiment, an apparatus is provided. The apparatus includes at least one memory for storing data and computer-executable instructions; and at least one processor configured to access the at least one memory and further configured to execute the computer-executable instructions for: receiving power rating information for the at least one power transformer; receiving load information from the one or more meters supplied by the at least one power transformer; summing the received load information; comparing the summed load information to the received power rating information; and determining spare load capacity associated with the least one power transformer based at least in part on the comparison.

Other embodiments, features, and aspects of the invention are described in detail herein and are considered a part of the claimed inventions. Other embodiments, features, and aspects can be understood with reference to the following detailed description, accompanying drawings, and claims.

### BRIEF DESCRIPTION OF THE FIGURES

Reference will now be made to the accompanying tables and drawings, which are not necessarily drawn to scale, and wherein:

FIG. 1 is a block diagram of an illustrative overload protection system according to an example embodiment of the invention.

FIG. 2 is a method flow diagram according to an example embodiment of the invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain embodiments of the invention may mitigate the risk of equipment failure without the need to deploy additional hardware beyond advanced metering infrastructure (AMI) smart meters and an AMI communication system. According to certain example embodiments, the AMI communications system may be utilized to monitor loads at one or more AMI smart meters that are connected to a given power transformer. According to an example embodiment, a plug-in electrical vehicle (PEV) or other large load may be detected by monitoring the individual AMI meter load. Example embodiments of the invention may sum the individual meter loads and compare the sum to the load rating of the power transformer. In an example embodiment, the spare capacity may be determined based on the comparison. According to an example embodiment, demand-response messages may be sent to individual homes to set the price for the power usage based on the amount of spare capacity and/or on the detection of a PEV.

According to example embodiments of the invention, various meters, controllers, and communication systems may be used for monitoring power usage, determining capacity, and communicating pricing, and will now be described with reference to the accompanying figures.

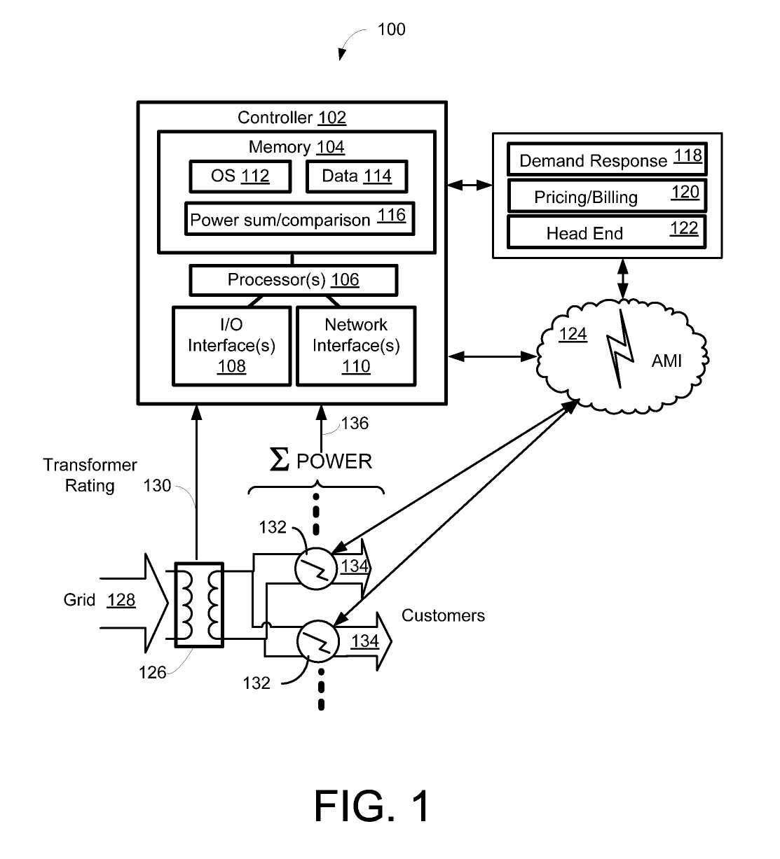

FIG. 1 illustrates an example overload protection system 100. The system 100 can include an electrical grid 128 that can supply power to one or more customers 134 via a transformer 126 and one or more AMI meters 132. The transformer 126 may be rated with a certain power rating 130. The system 100 may also include a controller 102 that may be in communication with an AMI network 124 and the AMI meters 132. According to an example embodiment, the controller 102 may query the individual AMI meters 132 through the AMI network 124. In another example embodiment, the AMI meters 132 may send time-stamped to the controller via the AMI network 124 at predetermined time intervals. According to an example embodiment, the AMI network may me wired or wireless, or a combination of both.

According to example embodiments of the invention, the controller 102 may communicate with the AMI meters 132 via the network interface(s) 110 and/or by the input/output interfaces 108. In an example embodiment, the controller 102 includes a memory 104, and one or more processors 106. In an example embodiment, the memory can include an operating system 112, data 114, and a power sum and comparison module 116. In an example embodiment, the controller may receive transformer rating information 130 associated with the power transformer 126. The controller may also receiver the individual power usage readings for each AMI meter 132. In an example embodiment, the power sum and comparison module 116 may receive readings from each of the AMI meters 132 attached to the transformer 126 and may compute the sum 136 of the power readings. In an example embodiment, the power sum and comparison module 116 may then compare the sum 136 to the transformer rating information 130 to determine the spare capacity (or lack thereof) associated with the transformer 126.

According to an example embodiment, controller 102 may communicate the spare capacity data with the head end 122, which may be in communication with a pricing/billing system 120. According to an example embodiment, the pricing/billing system 120 may be in communication with a demand/response system 118. In an example embodiment, the spare capacity data provided by the controller 102 may be used by the pricing/billing system 120 and the demand/response system 118 to generate and send messages to the AMI meters 132.

According to another example embodiment (not shown), the controller 102 may include a pricing/billing module. According to an example embodiment, the pricing/billing module may be in communication with a demand/response module. In an example embodiment, the spare capacity data computed by the power sum/comparison module 116 may be used by the pricing/billing module and the demand/response module to generate and send messages to the AMI meters 132.

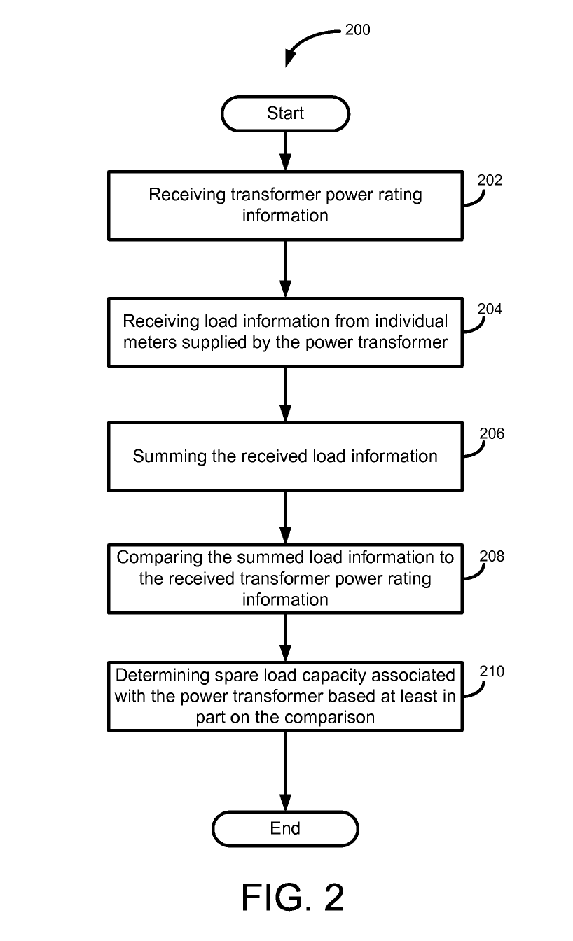

An example method 200 for protecting a power transformer from overload will now be described with reference to the flowchart of FIG. 2. The method 200 starts in block 202 and includes receiving transformer power rating information. In block 204, the method 200 includes receiving load information from individual meters supplied by the power transformer. In block 206, the method 200 includes summing the received load information. In block 208, the method 200 includes comparing the summed load information to the received transformer power rating information. In block 210, the method 200 includes determining spare load capacity associated with the power transformer based at least in part on the comparison. Method 200 ends after block 210.

Example embodiments of the invention include setting prices for electricity based at least in part on the spare load capacity. In certain embodiments, setting prices is based on a detected presence and number of plug-in vehicles. Example embodiments include sending one or more demand response messages to the individual meters 132. In an example embodiment, the one or more demand response messages include price information. In an example embodiment, the one or more demand response messages are utilized for limiting power to one or more customers 134. According to example embodiment, power is limited by one or more individual meters 132. According to an example embodiment, a control command may be sent to one or more electrical vehicle chargers to limit or stop charging if a load associated with the power transformer exceeds a safe operating limit or predetermined limit.

Example embodiments of the invention include a system and apparatus. The system can include one or more meters 132 and at least one power transformer 126) operable to provide power to the one or more meters 132. The system and apparatus can include at least one memory 104 for storing data 114 and computer-executable instructions 116; and at least one processor 106 configured to access the at least one memory 104 and further configured to execute the computer-executable instructions 116 for receiving power rating information 130 for the at least one power transformer 126; receiving load information (136) from the one or more meters 132 supplied by the at least one power transformer 126; summing the received load information 136; comparing the summed load information to the received power rating information 130; and determining spare load capacity associated with the least one power transformer 126 based at least in part on the comparison.

According to an example embodiment, the at least one processor 106 is further configured for setting prices for electricity based at least in part on the spare load capacity. In an example embodiment, setting prices is based on a detected presence and number of plug-in vehicles. Example embodiments of the system and/or apparatus include an advanced metering infrastructure network 124 for sending one or more demand response messages to the individual meters 132. In an example embodiment, the one or more demand response messages include price information. In an example embodiment, the one or more demand response messages are utilized for limiting power to one or more customers 134. According to an example embodiment, power can be limited by the one or more meters 132. According to an example embodiment, at least one processor may be configured to send a control command to one or more electrical vehicle chargers to limit or stop charging if a load associated with the power transformer exceeds a safe operating limit or predetermined limit.

According to example embodiments, certain technical effects can be provided, such as creating certain systems, methods, and apparatus that can charge customers for overloading equipment and reducing the life of equipment. Example embodiments of the invention can provide the further technical effects of providing systems, methods, and apparatus for mitigating the risk of equipment failure.

In example embodiments of the invention, the overload protection system 100 may include any number of hardware and/or software applications that are executed to facilitate any of the operations.

In example embodiments, one or more I/O interfaces may facilitate communication between the overload protection system 100 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the overload protection system 100. The one or more I/O interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the overload protection system 100 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network any wired network, any wireless network, etc., for communication with external devices and/or systems.

As desired, embodiments of the invention may include the overload protection system 100 with more or less of the components illustrated in FIG. 1.

Certain embodiments of the invention are described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method for protecting a power transformer from overload, the method comprising:
receiving transformer power rating information;
receiving load information from individual meters supplied by the power transformer;
summing the received load information;
comparing the summed load information to the received transformer power rating information; and
determining spare load capacity associated with the power transformer based at least in part on the comparison.

2. The method of claim 1, further comprising setting prices for electricity based at least in part on the spare load capacity.

3. The method of claim 2, wherein setting prices is based on a detected presence and number of plug-in vehicles.

4. The method of claim 1, further comprising sending one or more demand response messages to the individual meters.

5. The method of claim 4, wherein the one or more demand response messages comprise price information.

6. The method of claim 4, wherein the one or more demand response messages are utilized for limiting power to one or more customers.

7. The method of claim 1, further comprising sending a control command to one or more electrical vehicle chargers to limit or stop charging if a load associated with the power transformer exceeds a safe operating limit or predetermined limit.

8. A system comprising:
one or more meters;
at least one power transformer operable to provide power to the one or more meters;
at least one memory for storing data and computer-executable instructions; and
at least one processor configured to access the at least one memory and further configured to execute the computer-executable instructions for:
receiving power rating information for the at least one power transformer;
receiving load information from the one or more meters supplied by the at least one power transformer;
summing the received load information;
comparing the summed load information to the received power rating information; and
determining spare load capacity associated with the least one power transformer based at least in part on the comparison.

9. The system of claim 8, wherein the at least one processor is further configured for setting prices for electricity based at least in part on the spare load capacity.

10. The system of claim 9, wherein setting prices is based on a detected presence and number of plug-in vehicles.

11. The system of claim 8, further comprising an advanced metering infrastructure network for sending one or more demand response messages to the individual meters.

12. The system of claim 11, wherein the one or more demand response messages comprise price information.

13. The system of claim 8, wherein the at least one processor is configured to send a control command to one or more electrical vehicle chargers to limit or stop charging if a load associated with the power transformer exceeds a safe operating limit or predetermined limit.

14. The system of claim 13, wherein power is limited by the one or more meters.

15. An apparatus comprising:
at least one memory for storing data and computer-executable instructions; and
at least one processor configured to access the at least one memory and further configured to execute the computer-executable instructions for:
receiving power rating information for at least one power transformer;
receiving load information from one or more meters supplied by the at least one power transformer;
summing the received load information;
comparing the summed load information to the received power rating information; and
determining spare load capacity associated with the least one power transformer based at least in part on the comparison.

16. The apparatus of claim 15, wherein the at least one processor is further configured for setting prices for electricity based at least in part on the spare load capacity.

17. The apparatus of claim 16, wherein setting prices is based on a detection of a plug-in vehicle.

18. The apparatus of claim 15, further comprising an advanced metering infrastructure network for sending one or more demand response messages to the individual meters.

19. The apparatus of claim 18, wherein the one or more demand response messages comprise price information.

20. The apparatus of claim 15, wherein the at least one processor is configured to send a control command to one or more electrical vehicle chargers to limit or stop charging if a load associated with the power transformer exceeds a safe operating limit or predetermined limit.
